(19) United States
(12) Patent Application Publication
(10) Pub. No.: US 2002/0193091 A1
(43) Pub. Date: Dec. 19, 2002

(54) Emergency response system

(76) Inventor: Kevin Zmarthie, Oakland, CA (US)

Correspondence Address: KEVIN ZMARTHIE, C/O PAT HANSEN, 4096 PIEDMONT AVE #189, OAKLAND, CA, 94611, US

(21) Appl. No.: 10/105,136

(22) Filed: Mar. 22, 2002

Related U.S. Application Data
(63) Continuation-in-part of application No. 09/570,066, filed on May 12, 2000.

(51) Int. Cl. H04M 11/00; H04Q 7/20

(52) U.S. Cl. 455/404; 455/456; 455/419

(57) ABSTRACT

To generate an emergency distress signal, an automatic call for help, should the person wearing the device be rendered helpless, unconscious, or unable to talk or communicate. The unit transmits a continuous wave coded burst on a worldwide emergency distress frequency to the emergency dispatch receiver. The signal contains the subscriber ID code and current position from the Global Positioning System (GPS) which includes latitude and longitude. The unit combines a continuous wave transceiver and antenna, GPS-navigational positioning system receiver and antenna, accelerometer switches, and speaker merged into a single unit. Continuous wave is used to extend the range of the unit to underground parking garages or other out-of-the-way places where cell phone coverage is inhibited. The unit contains two accelerometer switches to activate the unit should the wearer be unable to respond because of a fall, or if rendered unconscious.

The receiving end (emergency dispatch receiver) interpolates the short continuous wave transmission, (ID number, Lat./Long, Global Positioning System PLOT,) displays the subscriber ID, medical history records, and a tracking map on the computer screen. It shows the exact location (Global Positioning System accuracy within 13 feet) of the individual and displays the proper medical prompts according to patient's history or recorded instructions. The operator need only read a standard computer display to know that the client has an emergency, their exact location, and using proper dispatch procedures, to call the emergency contact indicted in the client's history.

### CROSS REFERENCE TO RELATED APPLICATIONS

This application is a Continuation-in-Part of application Ser. No. 09/570,066 file May 12, 2000.

### BACKGROUND

1. Field of Invention

The present invention relates to a signaling system that automatically generates an emergency distress signal, containing personal identification and Global Positioning System location of the person in distress, and transmits that signal in a continuous wave broadcast on an emergency distress frequency to a control information center that can determine the appropriate emergency response and notify and dispatch response procedures and personal.

2. Description of Prior Art

The closest art, U.S. Pat. No. 5,940,044, (“Fulton”), relates to a recovery system that provides automatic warnings at predetermined times. It transmits emergency information via cellular telephone, which can be unreliable.

The ERU does not emit signals at predetermined times, but transmits if activated by the wearer, if the accelerometer detects unusual movement or if it receives an alarm from an outside monitoring device that might be attached through a ground closure.

The ERU specifies use of a continuous wave transmission using abbreviated Morse code. No modulated signal is used, thus allowing the ERU to transmit at approximately ten times the power of a cellular phone signal. This allows the ERU to transmit from basement and parking garage locations where Fulton won't transmit.

The ERU does not require the usual FCC license for a device of this power output, because it uses the emergency frequency band for transmission since the transmissions relate to emergencies and are short bursts of information.

U.S. Pat. No. 5,742,233 (“Hoffman et al”) also uses an GPS signal, but like Fulton links the device to security, stressing personal safety, a means of sounding an alarm if the wearer is under threat of forceful or unauthorized action or if the device is removed from the wearer improperly. Hoffman also specifies transmission of the alarm via cellular phone or personal communications system (PCS). The ERU specifies use of continuous wave transmission on any of the emergency band frequencies.

### SUMMARY

In accordance with the present invention, an electronic locator/signaling device that uses a continuous wave (CW) transmission of high power, utilizing abbreviated code on emergency broadcast frequencies comprises a Global Positioning System (GPS) receiver, a GPS antenna, a radio signal transmitter/receiver, an electronic signal mixing device to mix output from said GPS receiver and signal transmitter/receiver, a microprocessor device, an electronic I/O port, a speaker, a power supply and two emergency activation switches to interface with said microprocessor device, and A CW transmit/receive antenna.

### OBJECTS AND ADVANTAGES

Besides the objects and advantages of the Emergency Response Unit described in my patent, several objects and advantages of the present invention are:

a) to give the user the means of signaling for assistance in case of an emergency;

b) to signal for assistance when the device detects unusual motion;

c) to allow the user to interrupt the distress signal;

d) to interface with a wide range of electronic devices through the I/O ports;

e) to be used globally;

f) to rely on non congested frequencies to transmit;

g) to use a continuous wave transmission to enhance range of transmission;

h) to use continuous wave transmission which allows broadcast with up to ten times the power of existing art because all the power of this present art is concentrated in the carrier frequency (with no side bands) which is turned off and on to send a message;

i) to avoid use of the 911 telephone emergency system as a default, and contact the care provider elected by the user;

j) to pin-point the user within thirteen square feet;

k) to emit a distress call triggered by an exterior device such as but not limited to a health monitoring device;

l) to send signals over phone lines, if necessary;

m) to transmit a signal successfully from locations where other devices could not, for example, parking garages, or subterranean areas;

n) to operate as a pager device;

o) to allow the sensitivity of the emergency activation switches to be calibrated to the weight of the user;

p) to interface with any compatible wireless device;

q) to transmit over alternate transmitter/receiver;

r) to add “at home” message to outgoing signal if the user is within range of the recharger device;

s) to provide recharge through AC/DC or electromagnetic induction;

t) to include altitude in the outgoing signal;

u) to conform to ruggedized standards so the unit can withstand reasonable impact;

v) to allow the user the opportunity to terminate the signal prior to transmission in case of false alarms or accidental activation;

w) to transmit an “I'm okay” signal to confirm a false alarm or accidental activation;

x) to provide for the transmission of a test signal to confirm the functionality of the unit;

y) to emanate an audible signal when the battery is low.

### DRAWING FIGURES

FIG. 1 shows schematic of the preferred embodiment of the Emergency Response Unit

FIG. 2 shows the Emergency Response Unit with the addition of user controls as described in dependent claim 11

FIG. 3 shows the Emergency Response Unit with the addition of user controls and an altimeter, as described in dependent claim 12

FIG. 4 shows the Emergency Response Unit with the addition of user controls and a ground closure connection, as described in dependent claim 13

FIG. 5 shows the Emergency Response Unit with the addition of user controls, altimeter, a ground closure connection as described in dependent claim 14

FIG. 6 shows the Emergency Response Unit with the addition of user controls, altimeter, a ground closure connection, and display screen, as described in dependent claim 15

FIG. 7 shows the Emergency Response Unit with the addition of user controls, altimeter, a ground closure connection, display screen, vibrator, pager and alternate I/O ports as described in dependent claim 16

FIG. 8 shows the Emergency Response Unit with the addition of user controls, altimeter, a ground closure connection, display screen, vibrator, alternate I/O ports, alternate microprocessor device, alternate transceiver, and alternate antenna as described in dependent claim 17

FIG. 9 shows the Emergency Response Unit with the addition of user controls, altimeter, a ground closure connection, display screen, vibrator, alternate I/O ports, alternate microprocessor device, alternate transceiver, alternate antenna and modem as described in dependent claim 18.

FIG. 10 shows the Emergency Response Unit with the addition of user controls, altimeter, a ground closure connection, display screen, vibrator, alternate I/O ports, alternate microprocessor device, alternate transceiver, alternate antenna, modem and pager as described in dependent claim 19

FIG. 11 shows the Emergency Response Unit with the addition of user controls, altimeter, a ground closure connection, display screen, vibrator, alternate I/O ports, alternate microprocessor device, alternate antenna, and wireless connectivity means as described in dependent claim 20

FIG. 12 shows the Emergency Response Unit with the addition of user controls, altimeter, a ground closure connection, display screen, vibrator, pager, alternate I/O ports alternate microprocessor device, alternate antenna, wireless connectivity means and pager as described in dependent claim 21

FIG. 13 shows the Emergency Response Unit with the addition of user controls, altimeter, a ground closure connection, display screen, vibrator, alternate I/O ports, alternate microprocessor device, alternate antenna, wireless connectivity means, pager and modem as described in dependent claim 22

FIG. 14 shows the Emergency Response Unit with the addition of user controls, altimeter, a ground closure connection, display screen, vibrator, alternate I/O ports, alternate microprocessor device, alternate transceiver device, alternate antenna, wireless connectivity means, pager and modem as described in dependent claim 23

FIG. 15 lays out the Functional Diagram of the Emergency Response Unit as depicted in FIG. 14

FIG. 16 show a Block Diagram of Operation of Complete Emergency Response System including the Control Information Center

REFERENCE NUMERALS IN DRAWINGS

| | | | |
|---|---|---|---|
| (1) | Global Positioning System | (10) | Ground Closure |
| | Receiver | | Connection |
| (2) | Personal subscriber ID | (11) | Screen |
| | information | (12) | Alternate I/O Port |
| (3) | Buffer/adder/encoder | (13) | User Controls |
| (4) | Power Supply | (14) | Speaker |
| (5) | Microprocessor (ERU) | (15) | In/Out Port |
| (6) | Accelerometer switches | (16) | GPS antenna |
| (7) | Continuous wave transmitter | (17) | CW antenna |
| (8) | Receiver | (18) | Control Information |
| (9) | Modem | | Center (CIC) |
| (19) | Emergency Response Unit | (27) | Modem/Phone Lines |
| (20) | Antenna Array | (28) | Altimeter |
| (21) | Receiver | (29) | Pager |
| (22) | Transmitter | (30) | Wireless connectivity |
| (23) | Data Modem/Converter/Buffers | | device |
| (24) | In-line Computer | (31) | Alternate transmitter/ |
| (25) | Display | | receiver |
| (26) | Control Information Center | (32) | Alternate Antenna |
| | Computer | (33) | Vibrator |
| | | (34) | alternate |
| | | | microprocessor |

### DESCRIPTION

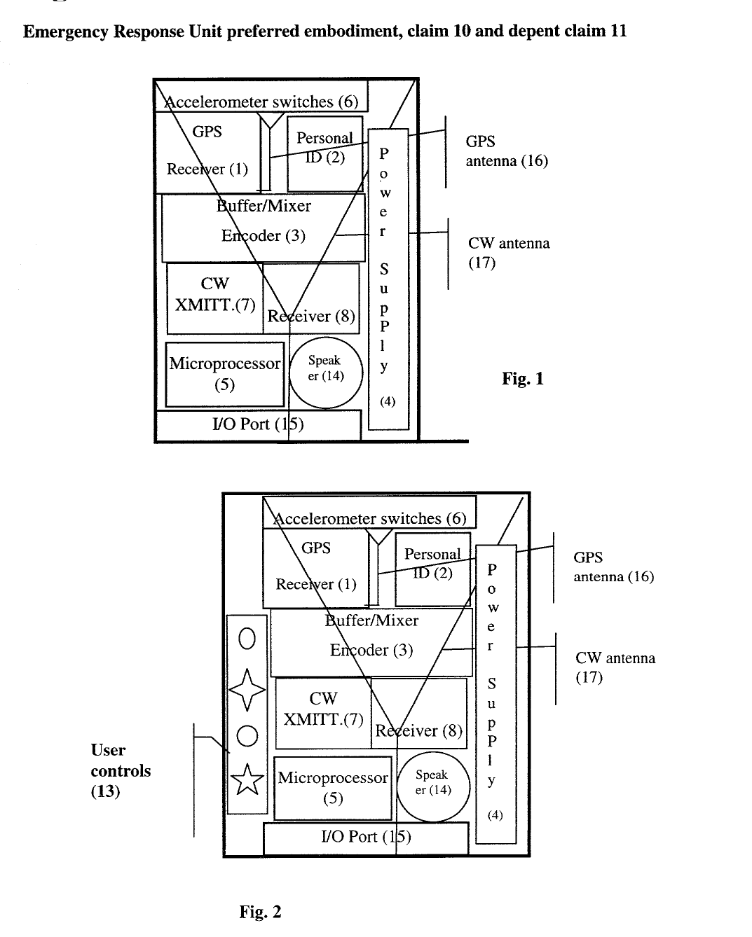

FIG. 1—The Emergency Response Unit

A preferred embodiment of the system is illustrated in FIG. 1.

Static State:

The unit receives information through the GPS antenna (16), to the incorporated Global Positioning System Receiver (1) and adds the information to Personal subscriber ID information (2) in the Buffer/adder/encoder (3). This information is constantly changing as a person moves about so that the exact location in latitude and longitude are readably available. The unit draws minimal power from the power supply (4).

Dynamic Operation (Emergency Response):

The wearer of the device falls in a basement parking garage, and is unconscious. The Accelerometer switches (6) will activate the unit and send an emergency distress signal which consists of personal ID, and latitude/longitude location repeatedly via continuous wave transmission from the CW transmitter (7) over the CW antenna (17). The un-modulated continuous wave signal is received at the Control Information Center in many instances where a cellular phone or standard UHF/VHF (walkie-talkie) transmission would be impossible.

FIGS. 2, Through 13—Additional Embodiments

FIG. 2 depicts The Emergency Response Unit with the addition of user controls (13).

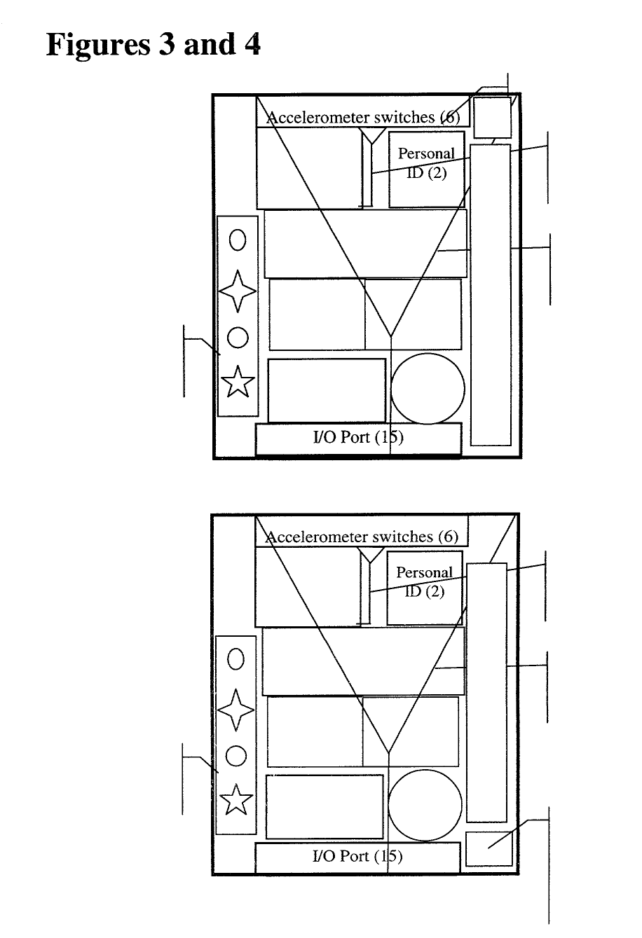

FIG. 3 shows the Emergency Response Unit with the addition of user controls (13) and an altimeter (28), allowing the wearers altitude to be included in the emergency transmission.

FIG. 4 shows the Emergency Response Unit with addition of user controls (13) and a ground closure connection (10), which allows the unit to interface with a wide range of electronic devices.

FIG. 5 shows the Emergency Response Unit with addition of user controls (13) a ground closure connection (10), and altimeter (28).

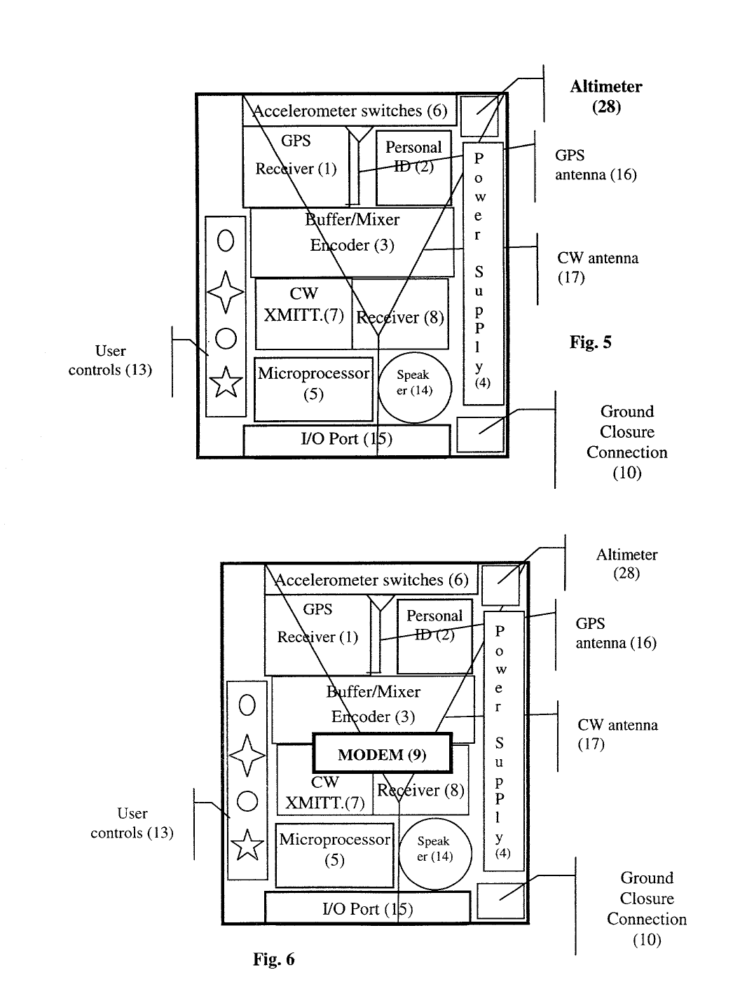

FIG. 6 shows the Emergency Response Unit with the addition of user controls (13), altimeter (28), a ground closure connection (10) and display screen (11), which allows for the display of text messages.

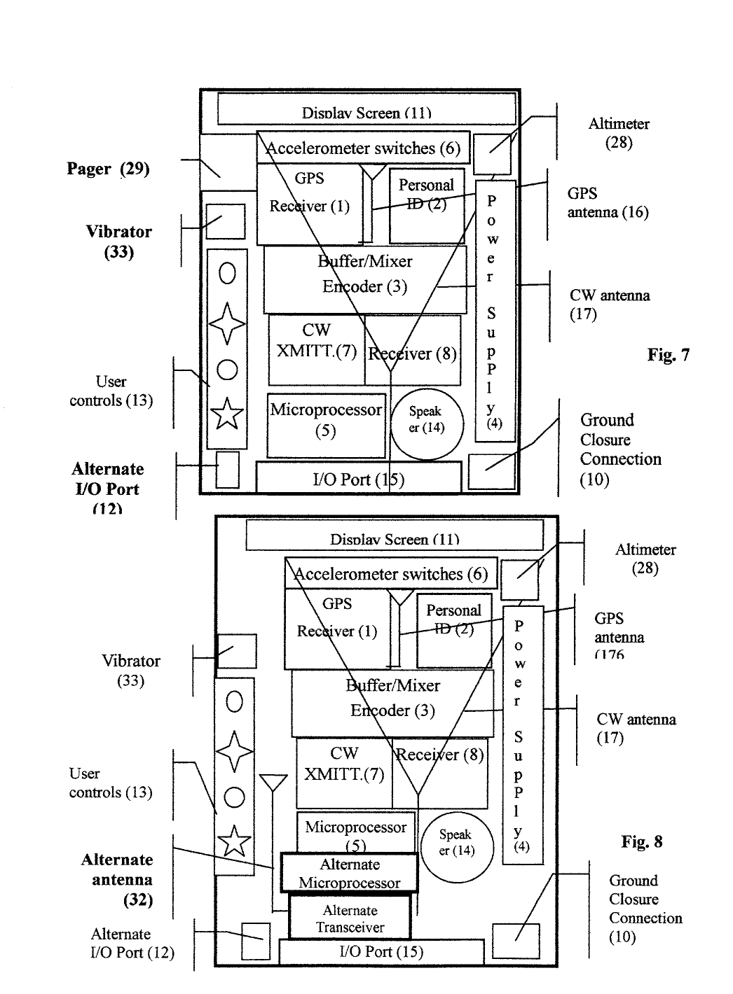

FIG. 7 shows the Emergency Response Unit with the addition of user controls (13), altimeter (28), a ground closure connection (10), display screen (11), vibrator (33), pager (29), alternate I/O ports (12), which affords the unit additional connectivity.

FIG. 8 shows the Emergency Response Unit with the addition of user controls (13), altimeter (28), a ground closure connection (10), display screen (11), vibrator (33), alternate I/O ports (12), alternate microprocessor device (34), alternate transceiver (31) and alternate antenna (32), allowing for a redundant means of transmission.

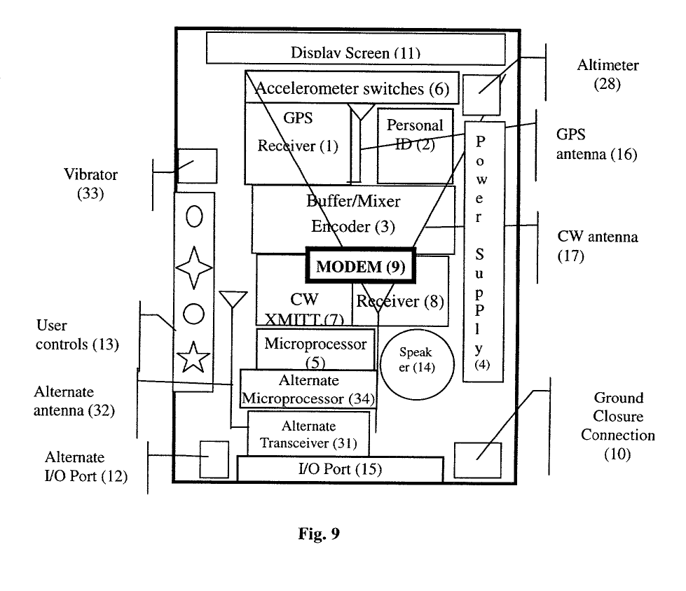

FIG. 9 shows the Emergency Response Unit with the addition of user controls (13), altimeter (28), a ground closure connection (10), display screen (11), vibrator (33), pager (29), alternate I/O ports (12), alternate microprocessor device (34), alternate transceiver (31), alternate antenna (32), and modem (9) which allows the unit to communicate over standard telephone lines.

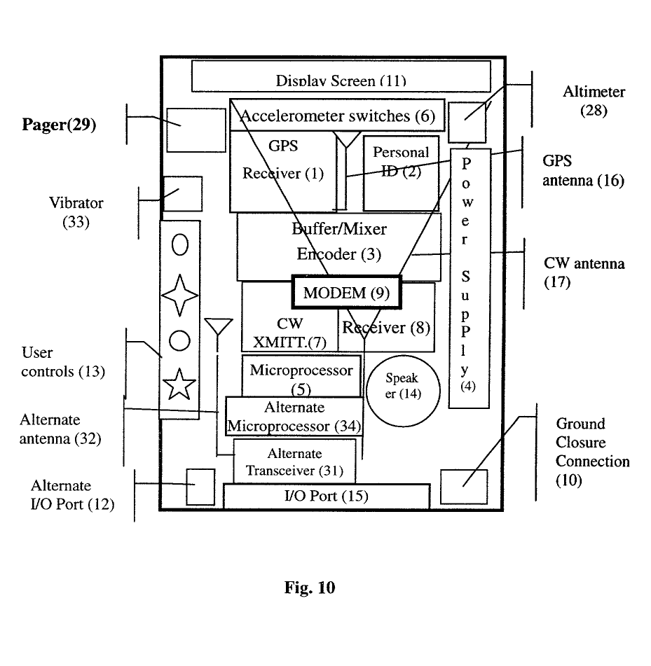

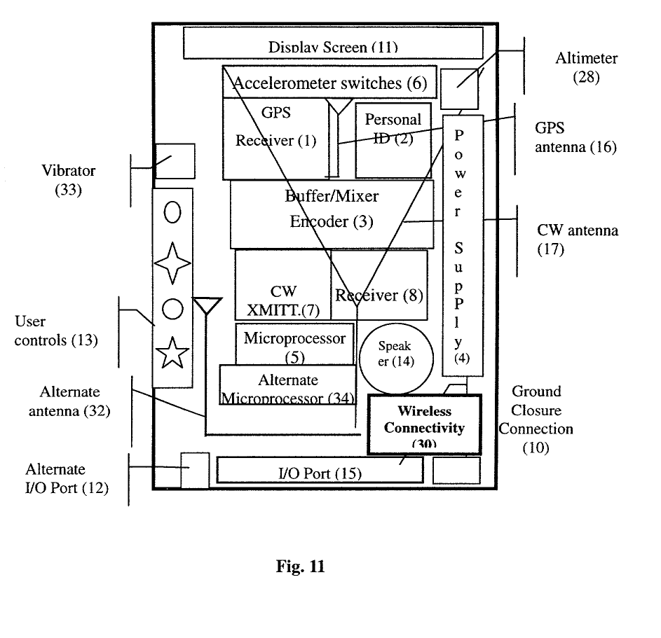

FIG. 10 shows the Emergency Response Unit with the addition of user controls (13), altimeter (29), a ground closure connection (33), display screen (11), vibrator (33), pager (29), alternate I/O ports (12), alternate transceiver (31), alternate microprocessor device (34), alternate antenna (32), modem (9) and pager (29).

FIG. 11 shows the Emergency Response Unit with the addition of user controls (13), altimeter (28), a ground closure connection (10), display screen (11), vibrator (33), pager (29), alternate I/O ports (12), alternate microprocessor device (34), alternate antenna (32), and wireless connectivity means (30) which allows the unit to communicate with wireless devices.

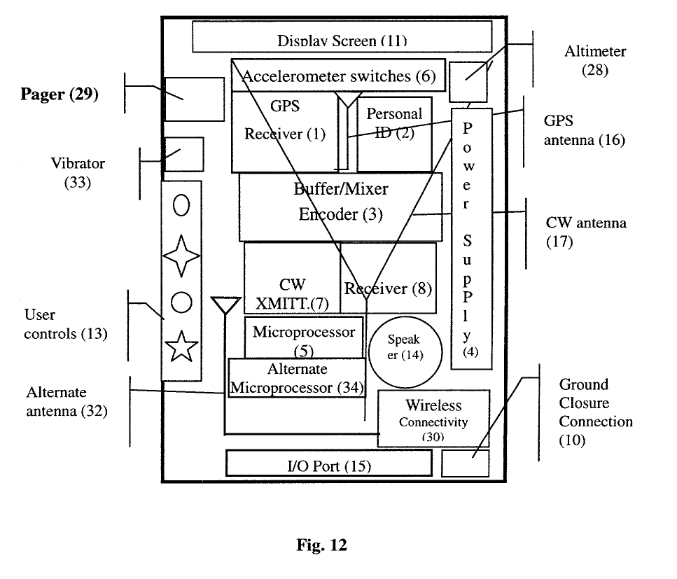

FIG. 12 shows the Emergency Response Unit with the addition of user controls (13), altimeter (28), a ground closure connection (10), display screen (11), vibrator (33), alternate I/O ports (12), alternate microprocessor device (34), alternate antenna (32), wireless connectivity means (31), and pager (29).

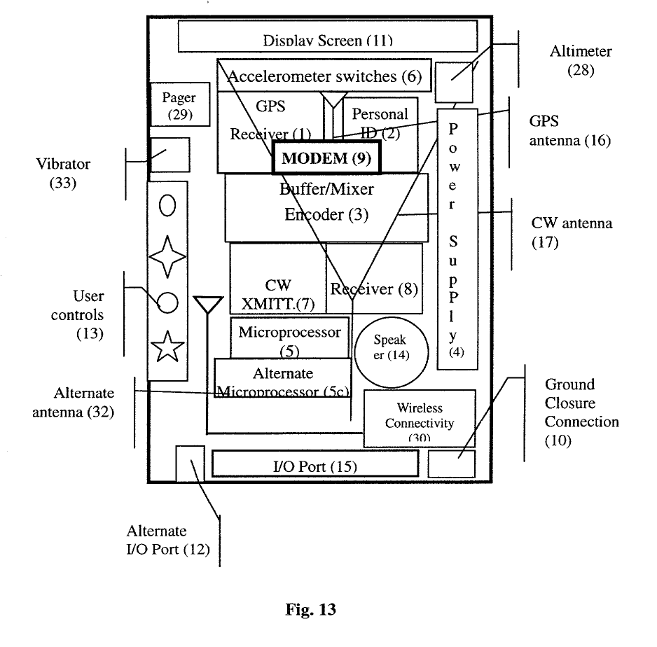

FIG. 13 shows the Emergency Response Unit with the addition of user controls (13), altimeter (28), a ground closure connection (10), display screen (11), vibrator (33), pager (29), alternate I/O ports (12), alternate microprocessor device (34), alternate antenna (32), wireless connectivity means (31), pager (29), and modem (9).

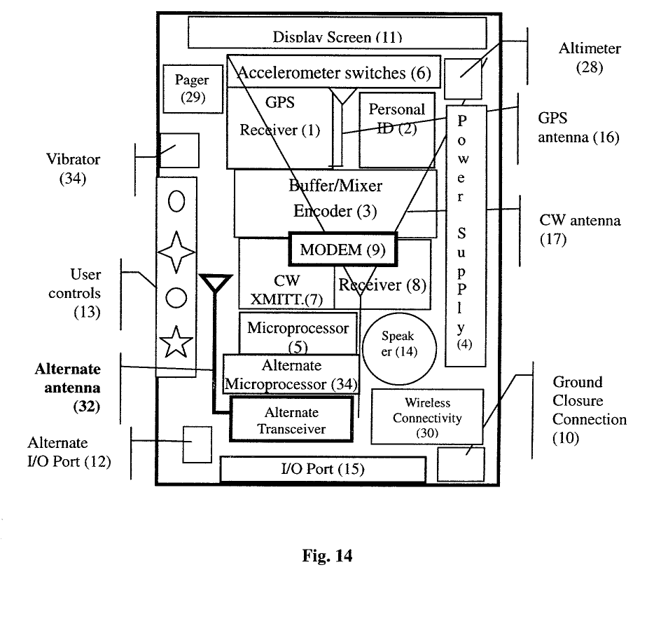

FIG. 14 shows the Emergency Response Unit with the addition of user controls (13), altimeter (28), a ground closure connection (10), display screen (11), vibrator (33), pager (29), alternate I/O ports (12), alternate microprocessor device (34), alternate transceiver (31), alternate antenna (32), wireless connectivity means (31), pager (29), and modem (9).

Advantages

The Continuous Wave design of the Emergency Response Unit allows the unit to emit a more powerful signal than other units because the power is used to transmit the carrier frequency and not to modulate the signal on the side bands of the carrier frequency. Couple this with using frequencies reserved for emergency use and the ERU becomes much more reliable than other response units. Because the signal is designed for broadcast on emergency frequencies, the unit has the capability of world-wide range. Because the signal is broadcast to a private Control Information Center, it does not use the standard, and sometimes over-used, 911 emergency system, so assistance can be dispatched in a more timely fashion.

The multiple I/O Ports allows the ERU to interface with many other devices including, but not limited to, medical monitoring devices. An alarm from on of these devices can be used to trigger the Emergency Response Unit.

Operations—FIGS. 15 and 16

FIG. 15 shows the unit constantly receives information via the GPS antenna (16), which relays that signal to the GPS receiver (global positioning system) (1) in the form of a latitude and longitude plot. An example: Lat:N 37° 44″ 15′, Long: W 78° 20″ 42′. This is an exact address on the surface of the earth and using this information a person's exact location within a few feet can be plotted on a map.

This GPS information from the GPS receiver (1) along with personal subscriber identification codes from the programmable memory in (2) are mixed in the buffer, mixer, encoder module (3). Information at this point is converted into a code for use by the Continuous Wave (CW) transmitter (7), which will broadcast the distress signal repeatedly via the CW antenna (17) in the emergency distress frequency band as a CW transmission.

The additional embodiment depicted in FIG. 14, included a pager (29) to receive text messages, a modem (9) to communicate via standard phone lines, an alternate microprocessor (34), alternate transceiver (31), and alternate antenna (32), for a second means of communication, as well as wireless connectivity (30) to interface with wireless devices. A ground closure connection (10) and alternate In/Out ((I/O) port (12) facilitate connectivity to other devices and a vibrator (33) can be used to send alerts to the user.

CW or continuous wave transmission turns the carrier frequency on and off to send a message, putting all of the transmit power into the center carrier frequency and none in a modulated side band allowing for an extended range and more powerful signal being broadcast. This allows the unit to transmit from more remote locations like parking garages, tunnels and other enclosed building or basement situations where cellular telephones and standard UHF, VHF transmissions will not work for reliable communications.

The coded CW message is only a short burst of information, yet at the receiving end the burst interpolates to complete medical history, addresses, phone numbers and the exact location of where the person is now located. Emergency procedures are initiated from the Central Information Center.

The Accelerometer switches (6) activate the unit automatically should the wearer be involved in any motion that exceeds normal movement, examples could be an auto accident, or a fall, slipping on ice or stairs would be good examples as to what would activate the unit.

An audible beep occurs at the unit for 15 seconds, after which the unit transmits (7) the emergency distress signal repeatedly to the CIC (Control Information Center), unless the wearer resets the unit (via reset button) prior to transmission.

Once transmission has occurred, the unit sends out an audible Help! Help! Help! via the local speaker system (14).

When the Central Information Center has activated emergency response procedures it also sends back acknowledgment information. The Continuous Wave Receiver (8) receives special coded emergency procedures that show up as text on the screen (11) and a simple SOS in dots and dashes that now becomes audible over the unit's speaker (14) so that now a passerby or the fallen person hears “Help, Help, Help, SOS, (dit, dit, dit, da, da, da, dit, dit, dit) SOS, SOS.” repeated in regular intervals until reset. This double audible code makes the fallen subscriber aware that his unit has transmitted and help has been dispatched, even in total darkness and without glasses.

FIG. 16 shows details of the operation of the Control Information Center. Signals are received through an antenna array and repeater system designed for 100% redundancy in metropolitan areas (20).

A standard VHF/UHF receiver (21) is tuned to the emergency distress frequency chosen. Its output is feed to a data converter (23), which translates the information for the computer (24), the computer displays the information about the subscriber, i.e. address, health history and other pertinent data that could be required in an emergency situation. An alarm notifies the operator that an emergency is in progress. The GPS positions that are part of the received information work with a maps program to show where the subscriber is located (13 feet accuracy). This information is displayed on monitor (25) and is also sent to remote computers and CIC Personal manning stations via (26) a phone line system (27) for initiation of emergency proceedures.

The CIC operator dispatches proper emergency vehicles and notifies personal according to his written instructions and also activates an outgoing coded message from his computer (26) that is reconverted to an outgoing CW signal and transmitted over standard transmission frequencies to be received by the distressed subscriber. This will activate the speaker (14) on his ERU letting him know he has been heard and help is on the way.

Conclusions, Ramifications, and Scope

It is the object of the present invention to provide a personal recovery unit to give the wearer a reliable means of sending a distress signal, even if they have fallen and are unconscious. The present art pinpoints the wearer's location to within 13 square feet, includes the components as shown in FIG. 1, and works as described in the operational description of the ERU.

The Unit can be modified with additional means, as shown is FIGS. 2 through 14, making it very adaptable. It can be used as a stand-alone unit, or connect to or be embedded in other electronic devices and systems. In several embodiments it offers a redundant means of transmission. In several other embodiments the ERU offers a wireless connectivity means so that the ERU can communicate with other wireless devices.

10) Preferred embodiment: An electronic locator/signaling device that turns off and on a continuous wave (CW) transmission of high power, to send a signal on emergency broadcast frequencies comprising
a) means for receiving Global Positioning System signals
b) means for transmitting and receiving continuous wave radio signals
c) means for electronic mixing s of output from said means for receiving Global Positioning System signals and said means for transmitting and receiving continuous wave radio signals
d) means for processing electronic signals from other components of the art
e) means for programmable storage of information, including but not limited to a unique personal identification number
f) means for sending out and receiving in electronic signals through a physical connection
g) means for determining unusual acceleration
h) means for intercepting Global Positioning System signal
i) means for intercepting continuous wave signal
j) means for supplying power
k) means for emitting sound

11) Same as 10) further including
a) means for allowing the user to interface with said Means for processing electronic signals from other components of the art

12) Same as 10) further including
b) means for allowing the user to interface with said means for processing electronic signals from other components of the art
a) means for determining altitude

13) Same as 10) further including
a) means for allowing the user to interface with said means for processing electronic signals from other components of the art
b) means for achieving a ground closure connection

14) Same as 10) further including
a) means for allowing the user to interface with said means for processing electronic signals from other components of the art
b) means for achieving a ground closure connection
c) means for determining altitude

15) Same as 10) further including
a) means for allowing the user to interface with said Means for processing electronic signals from other components of the art
b) means for achieving a ground closure connection
c) means for determining altitude
d) means for electronically displaying various symbols

16) The same as 1) further including
a) means for allowing the user to interface with said means for processing electronic signals from other components of the art
b) means for achieving a ground closure connection
c) means for determining altitude
d) means for electronically displaying various symbols
e) alternate means for sending out and receiving in electronic signals through a physical connection
f) means for receiving text messages
g) means wherein causes the unit to vibrate

17) The same as 1) further including
a) means for allowing the user to interface with said means for processing electronic signals from other components of the art
b) means for achieving a ground closure connection
c) means for determining altitude
d) means for electronically displaying various symbols
e) alternate means for sending out and receiving in electronic signals through a physical connection
f) means for receiving text messages
g) means wherein causes the unit to vibrate
h) second means for processing electronic signals from other components of the art
i) second means for transmitting and receiving a radio signal
j) second means for intercepting a radio signal

18) The same as 1) further including
a) means for allowing the user to interface with said means for processing electronic signals from other components of the art
b) means for achieving a ground closure connection
c) means for determining altitude
d) means for electronically displaying various symbols
e) alternate means for sending out and receiving in electronic signals through a physical connection
f) means for receiving text messages
g) means wherein causes the unit to vibrate
h) second means for processing electronic signals from other components of the art
i) second means for transmitting and receiving a radio signal
j) second means for intercepting a radio signal
k) modulation/demodulation device wherein allows for communication over telephone lines

19) The same as 1) further including
a) means for allowing the user to interface with said means for processing electronic signals from other components of the art
b) means for achieving a ground closure connection
c) means for determining altitude
d) means for electronically displaying various symbols
e) alternate means for sending out and receiving in electronic signals through a physical connection
f) means for receiving text messages
g) means wherein causes the unit to vibrate
h) second means for processing electronic signals from other components of the art
i) second means for transmitting and receiving a radio signal
j) second means for intercepting a radio signal
k) electronic means for receiving text message

20) The same as 1) further including
a) means for allowing the user to interface with said means for processing electronic signals from other components of the art
b) means for achieving a ground closure connection
c) means for determining altitude
d) means for electronically displaying various symbols
e) alternate means for sending out and receiving in electronic signals through a physical connection
f) means wherein causes the unit to vibrate
g) second means for processing electronic signals from other components of the art
h) second means for intercepting a radio signal
i) means for interfacing with other wireless devices

21) The same as 1 further including
a) means for allowing the user to interface with said means for processing electronic signals from other components of the art
b) means for achieving a ground closure connection
c) means for determining altitude
d) means for electronically displaying various symbols
e) alternate means for sending out and receiving in electronic signals through a physical connection
f) means wherein causes the unit to vibrate
g) second means for processing electronic signals from other components of the art
h) second means for intercepting a radio signal
i) means for interfacing with other wireless devices
j) an electronic means for receiving text messages

22) The same as 1) further including
a) means for allowing the user to interface with said means for processing electronic signals from other components of the art
b) means for achieving a ground closure connection
c) means for determining altitude
d) means for electronically displaying various symbols
e) alternate means for sending out and receiving in electronic signals through a physical connection
f) means wherein causes the unit to vibrate
g) second means for processing electronic signals from other components of the art
h) second means for intercepting a radio signal
i) means for interfacing with other wireless devices
j) an electronic means for receiving text messages
k) modulation/demodulation device wherein allows for communication over telephone lines

23) The same as 1) further including
a) means for allowing the user to interface with said means for processing electronic signals from other components of the art
b) means for achieving a ground closure connection
c) means for determining altitude
d) means for electronically displaying various symbols
e) alternate means for sending out and receiving in electronic signals through a physical connection
f) means wherein causes the unit to vibrate
g) second means for processing electronic signals from other components of the art
h) second means for transmitting and receiving radio signal
i) second means for intercepting a radio signal
j) means for interfacing with other wireless devices
k) an electronic means for receiving text messages
l) modulation/demodulation device wherein allows for communication over telephone lines
